(19) United States
(12) Patent Application Publication
(10) Pub. No.: US 2017/0001388 A1
(43) Pub. Date: Jan. 5, 2017

(54) A BODY COMPRISING A PARTICLE STRUCTURE AND METHOD FOR MAKING THE SAME

(71) Applicant: Condalign AS, Kjeller (NO)

(72) Inventor: Henrik HEMMEN, Oslo (NO)

(21) Appl. No.: 15/106,440

(22) PCT Filed: Dec. 19, 2014
(86) PCT No.: PCT/EP2014/078831

§ 371 Date: Jun. 20, 2016

(30) Foreign Application Priority Data
Dec. 20, 2013 (EP) 13198998.0

(51) Int. Cl. B29C 71/00; B29C 41/50; B29C 35/08; B29C 41/02

(52) U.S. Cl. CPC B29C 71/0072; B29C 41/02; B29C 41/50; B29C 35/0805; B29C 71/0081; B29C 2035/0827; B29K 2075/00

(57) ABSTRACT

The invention relates to a method for forming a body comprising a particle structure fixated in a matrix material, comprising: Providing an amount of particles, Providing a viscous matrix material to include said particles, Forming a particle structure of at least a portion of said amount of particles, Fixating said viscous matrix so as to fixate said particle structure in the matrix material; characterized by at least a portion of said amount of particles being paramagnetic or ferromagnetic and the formation of the particle structure includes the steps of: First, the particles are provided in a mixture with the viscous matrix material, Second, the viscous mixture is subject to the magnetic field created by a Halbach array so as to form the particle assemblies, Third, the viscous mixture with the particle assemblies is subject to electric field so as to move and/or rotate the particle assemblies in the viscous matrix material. The invention also relates to a body obtained by said method, and to the use of said method in various applications.

### TECHNICAL FIELD

The present invention relates to a method for forming a body comprising a particle structure fixated in a matrix material, comprising
Providing an amount of particles,
Providing a viscous matrix material to include said particles
Forming a particle structure of at least a portion of said amount of particles
Fixating said viscous matrix so as to fixate said particle structure in the matrix material.

### BACKGROUND OF THE INVENTION

Anisotropic materials are used in a wide and increasing range of applications. Typically, such materials include conductive particles fixated in a non-conductive matrix material. The conductive particles are intended to form conductive pathways in the matrix material, so as to enable the anisotropic material to be, at least under certain circumstances, electrically conductive.

Depending on the selection of particles and matrix materials, the anisotropic materials may be formed to be suitable for various applications, such as for sensors, such as stress sensors, in solar cell applications, printed electronics etc.

Prior art methods for forming anisotropic materials often involve providing a viscous mixture including the matrix material and conductive particles, applying an electric field over the viscous mixture so as to cause the conductive particles to align to form conductive pathways in the mixture, and thereafter curing the viscous mixture.

Alternatively, it has been proposed to use the magnetic properties of the particles to cause the particles to align and to form conductive pathways. WO 2008/153679 is such an example, where a viscoplastic material including a plurality of magnetic particles is subject to a magnetic field for a time sufficient to at least partially align a portion of the magnetic particles to a predetermined position.

EP0757407 discloses films and coatings having anisotropic conductive pathways therein, and methods for making the films and coatings. The method comprises applying a magnetic field from a Halbach magnetic cylinder.

US 2006/0244168 discloses a method and device for orienting magnetisable particles in a kneadable material. It is mentioned that a Halbach array may be used for providing a magnetic field. The Halbach array is included in a device, which is used for orienting magnetisable particles in a kneadable material.

To increase the versatility of the materials formed, and to enable industrial production thereof, there is a need for alternative methods for forming materials in this field.

It is an object of the invention to provide a method fulfilling said need.

### SUMMARY OF THE INVENTION

The above-mentioned object is achieved by a method for forming a body comprising a particle structure fixated in a matrix material, comprising
providing an amount of particles,
providing a viscous matrix material to include said particles,
forming a particle structure of at least a portion of said amount of particles, and
fixating said viscous matrix so as to fixate said particle structure in the matrix material.

In accordance with the method described herein, at least a portion of said amount of particles being paramagnetic or ferromagnetic, and
the formation of the particle structure includes the step of:
Subjecting the particles to a magnetic field created by a Halbach array, so as to arrange at least a portion of said particles into particle assemblies, each particle assembly comprising a plurality of particles and extending along a flux direction of said magnetic field. The Halbach array may or may not include a Halbach cylinder.

The particles may be subjected to the magnetic field by moving said particles through at least part of the magnetic field generated by the Halbach array.

The method described herein may also further comprise the step of:
Subjecting the particle assemblies to an electric field, so as to move and/or rotate said particle assemblies along a flux direction of said electric field.

Thus, there is provided a method as described herein, at least a portion of said amount of particles being paramagnetic or ferromagnetic, and the formation of the particle structure includes the steps of:
Subjecting the particles to a magnetic field created by a Halbach array, so as to arrange at least a portion of said particles into particle assemblies, each particle assembly comprising a plurality of particles and extending along a flux direction of said magnetic field, and
Subjecting the particle assemblies to an electric field, so as to move and/or rotate said particle assemblies along a flux direction of said electric field.

With “particle assembly” is meant herein a plurality of particles that have gathered under the influence of a magnetic field. The particle assemblies will have a generally elongate configuration with an extension along the flux direction of said magnetic field. For example, the particle assemblies may have the form of strings extending in the flux direction of the first field. For example, a particle assembly may comprise 3 or more particles, 10 or more particles or 50 or more particles.

In accordance with the method described herein, the particle assemblies are formed under the influence of a magnetic field created by a Halbach array. These particle assemblies have been found to be oriented in the same or substantially the same direction as the magnetic field lines of the Halbach array, and generally do not exhibit electrical conductivity.

Thereafter, the particle assemblies are subject to an electric field, which will have the effect of moving and/or rotating the particle assemblies so that the particles come closer together. Thus, the overall result of combining a magnetic field created by a Halbach array and an electric field is improved particle connectivity thereby allowing for better mechanical properties, such as strength, and/or electrical conductivity of the body of particles resulting from the method.

Depending on the concentration of particles, the assembly of particles will have the form of one or more linear or branched arrays as described above or one or more particle networks.

Thus, the method described herein using a combination of a magnetic field created by a Halbach array and an electric field may provide a body comprising a particle structure fixated in a matrix material with different and/or improved properties compared to methods using a magnetic field or an electric field only.

With “particle structure” is meant herein any desired configuration or structure of particles which is or is to be fixated in matrix material.

In accordance with the method described herein, the particle structure may be achieved after the particle assemblies have been subject to the electric field, moving and/or rotating the particle assemblies. Alternatively, the particle structure may be achieved after the particle assemblies have been subject to the magnetic field generated by the Halbach array.

The particle structure, which is to be fixated in the matrix material, may be achieved directly by the two steps described in the above: the creation of particle assemblies by a magnetic field created by a Halbach array and the subsequent moving and/or rotating of the particle assemblies by an electric field will hence immediately result in the particle structure to be fixated.

However, it is also possible to add additional fields for creating particle assemblies and/or for moving and/or rotating particle assemblies, in order to attain the desired particle structure. Hence, the particle assemblies could be subject to a third field, a fourth field and so on. Moreover, the magnetic field created by a Halbach array and the electric field as described in the above may be alternately applied to achieve a final particle structure.

At least a portion of said amount of particles is electrically conductive. This has the advantage that the particle structure may include an electrically conductive pathway formed by the electrically conductive particles.

The method described herein provides for forming a body comprising a particle structure fixated in a matrix material, wherein the formation of the particle structure includes:
First, the particles are provided separate from the matrix material,
Second, the particles are subject to the magnetic field created by a Halbach array so as to form the particle assemblies,
Third, the viscous matrix material is applied to the particle assemblies,
Fourth, the particle assemblies are subject to the electric field so as to move and/or rotate the particle assemblies in the viscous material

Thus, the particle assemblies are obtained by letting the particles be subject to a magnetic field created by a Halbach array. Thereafter, viscous matrix material is applied to the particle assemblies. For example, the matrix material may be poured over the particle assemblies. Thereafter, the viscous matrix material including the particle assemblies is subject to an electric field. Under the influence of the electric field, the particle assemblies may be moved and/or rotated in the matrix material.

The method described herein also provides for forming a body comprising a particle structure fixated in a matrix material, wherein the formation of the particle structure includes:
First, the particles are provided in a mixture with the viscous matrix material,
Second, the viscous mixture is subject to the magnetic field created by a Halbach array so as to form the particle assemblies,
Third, the viscous mixture with the particle assemblies is subject to electric field so as to move and/or rotate the particle assemblies in the viscous matrix material.

Thus, the particles are initially provided in a mixture with the viscous matrix material, and are subject to a magnetic field created by a Halbach array to form the particle assemblies. Thereafter, an electric field is applied to the viscous mixture, so as to move and/or rotate the particle assemblies.

It will be appreciated that the method described herein may include the application of a magnetic field created by one or more Halbach arrays only, i.e. the magnetic field may only be created by one or more Halbach arrays.

In one embodiment of the method described herein the rotation of the particle assemblies upon application of the electric field may be 90 degrees.

Advantageously, the method described herein may be used so as to form a particle structure including at least one pathway of particles extending through the matrix material. A pathway extending through the matrix material is such that the ends of said pathway may be connected to external devices. Preferably at least a portion of said particles are conductive such that the pathway is a conductive pathway. The method is hence suitable for forming a body having a conductive pathway through a matrix material, which may in turn have uses e.g. as a sensor.

The magnetic field is created by a so-called Halbach array. A Halbach array is a special arrangement of permanent magnets that augments the magnetic field on one side of the array while cancelling the field to near zero on the other side. It will be appreciated that the method described herein uses the magnetic flux on the one side of the Halbach array on which the magnetic field is augmented. The arrangement leads to a magnetic field structure on the augmented side where the field direction alternates from going parallel to the array, and perpendicular to the array. To a certain extent, this resembles the electric field structure over interdigitated finger electrodes The Halbach array may have the shape of a disk, such as a circular disk, or a ring. The Halbach array may be provided, for instance, by a refrigerator magnet, magnetic tapes, magnetic stripes, magnetic adhesive or magnetic paper many of which are commercially available at a low price The Halbach array may also be provided by a Halbach magnetic cylinder which may have a uniform magnetic field confined to the bore on the inside of the cylinder. Even though Halbach cylinders are known it is for this application preferred not to use a Halbach cylinder when the method herein includes the application of a magnetic field without including the application of an electric field. An advantage of the Halbach array is that when desired it allows for mixing the matrix material and the particles at a location that is separate from the location of Halbach array. A further advantage of the Halbach array is that it is often associated with simplicity and/or a low cost, such as in the case of refrigerator magnets or magnetic stripes. The Halbach array may comprise or consist of a NdFeB alloy, i.e. an alloy of the elements Neodymium, Iron and Boron. The Halbach array may be a single Halbach array. The Halbach array may or may not be in contact with the viscous matrix and/or the particles described herein.

In one aspect, the viscous matrix of the method described herein is stationary in relation to the Halbach array and vice versa. This is in contrast to, for instance, US 2006/0244168 which discloses that the magnet containing device is moved in relation to the matrix.

The time periods required for magnetic alignment depend on factors like the thickness of the sample, the viscosity of the polymer matrix and the susceptibilities of the magnetic particles. For example, advantageously the particles may be subject to the magnetic field created by a Halbach array for a time period being equal to or less than 60 seconds, preferably equal to or less than 30 seconds to form said particle assemblies. Using a magnetic field created by a Halbach array may be advantageous to enable formation of particle assemblies in time periods being equal to or less than 60 seconds, preferably equal to or less than 30 seconds.

When the particles are in a viscous mixture with the viscous matrix material, it is preferred that the particles have a concentration in the viscous matrix material being less than the percolation threshold.

For conductive mixtures a “percolation threshold” is defined as the lowest concentration of conductive particles necessary to achieve long-range conductivity in the random system. Such a random system is nearly isotropic. In a system formed by a method according to the invention the concentration of conductive particles necessary for achieving conductivity in a predefined direction is not determined by the percolation threshold and the concentration can be lower. For practical reasons the concentration of particles is determined by the requirements on the conductive paths, there usually being no reason to have excess amounts of conductive particles not arranged into the conductive paths.

The concentration of particles in the viscous matrix may be up to 10 times lower than the percolation threshold or even lower. Concentrations of particles may be in the range of 0.01-10 vol %, 0.01-4 vol %, 0.01-2 vol % or 0.01-1.5 vol %.

For example, the particles may have a concentration in the viscous matrix material in the range 0.1 to 2 vol %. Alternatively, the particles may have a concentration in the viscous matrix material in the range 0.1 to 1 vol %.

To be displaceable by use of a magnetic field, the particles may advantageously be paramagnetic of ferromagnetic, preferably ferromagnetic.

To be displaceable by use of an electric field, the particles may advantageously be electrically conductive and/or being made of one or more materials having a dielectric constant that is much smaller or much larger than that of the matrix.

The particles may be homogenous particles, i.e. a particle consists of a single material or material mixture throughout the particle. However, the particles may also be heterogeneous particles, i.e. a particle consists of several materials, for example the particle may have a core of one material, and a sheath of another material.

The particles to be subject of the fields in the proposed method may comprise only one type of particles, but may also be a mixture of different types of particles. Particles may be para-/ferromagnetic and/or electrically conductive.

The particles may be flat and/or have a spherical or irregular shape.

Magnetic particles may comprise a non-magnetic particle coated with a magnetic layer. Alternatively, magnetic particles may comprise magnetic particles coated with a non-magnetic layer. An example of a non-magnetic layer is a silver layer. An example of a magnetic particle is a magnetic carbon-nanostructure.

Advantageously, at least some particles may be both para- or ferro magnetic, and electrically conductive. Alternatively, there may be a mixture of paramagnetic or ferromagnetic particles. Such particles will be displaceable by both magnetic and electric fields.

Advantageously, the amount of particles includes particles of metal and/or metal alloys such as nickel or iron oxide. The particles may also include carbon such as graphite. Further, the particles may be selected from the group consisting of silver-iron particles, silver-nickel particles, graphite-nickel particles, nickel particles, carbon-nano particles and mixtures thereof.

The size of the particles, i.e. the largest linear dimension of the particles, may advantageously be in the range 0.5 micrometers to 150 micrometers.

The particles may have an aspect ratio from 1 to 100, from 1 to 20, from 1 to 10, from 1 to 5 or from 1 to 4. In this document, the aspect ratio is understood to mean the ratio of the particle length to the particle breadth.

Electric fields used with the method may advantageously have a field strength in the range of 1-20 kV/cm; preferably 5-15 kV/cm. The electric field may advantageously be an alternating field, preferably having a frequency in the range 10 Hz to 10 MHz, most preferred 0.1 kHz to 10 kHz.

The matrix material should be material having a viscous form which is capable of being fixed. Fixation may be achieved by any suitable method, such as, for example, cooling, curing, ceramisation, cross-linking, gelling, irradiating, drying, heating, sintering, or firing.

Advantageously, the matrix material comprises a polymer material. The polymer may be selected from the group consisting of polyurethanes, polyepoxides, epoxies, mercapto esters, polyacrylates, polyesters and combinations thereof. The polymer might also have the property of being a pressure sensitive adhesive, allowing the final embodiment to be used as a tape. Further, the polymer may comprise or consist of a pressure sensitive adhesive.

In particularly useful embodiments, the viscous matrix material may be UV-curable, and the fixating of the matrix material comprises UV curing thereof.

In other useful embodiments, the viscous matrix material may be humidity-curing, and the fixating of the matrix material comprises exposing the mixture to moisture, preferably in air at room temperature.

Advantageously the matrix material, when fixated, is an elastomeric material. This enables creation of bodies being useful for applications such as strain sensors, where the elastic properties of the matrix material is used together with the properties of the particle structure to achieve a desired function.

There is also provided a method for forming a body having a plurality of layers comprising particle structure fixated in matrix material, wherein at least one of said layers is formed by the method as described herein.

Advantageously, the matrix material of said at least one layer may be reduced before formation of another layer of the multi-layered structure thereupon. In this context, reduction of the matrix material intends partial or total removal of the matrix material.

Advantageously, in said method for forming a body having a plurality of layers, at least one layer may be formed by printing conductive pathways using one out of screen printing, and inkjet coating.

Advantageously, in said method for forming a body having a plurality of layers, at least two layers are formed by the method as described herein.

From a manufacturing point of view, the method described herein allows for a convenient way of producing a body comprising a particle structure fixated in a matrix material since, for instance, the particle composition and the matrix material may be easily varied according to the desired use and the time frame is short. In addition, the use of a Halbach array may be associated with a low cost when using, for instance, a Halbach array provided by commercially available low cost refrigerator magnets or magnetic tapes.

In another aspect, the invention relates to a body comprising a particle structure fixated in a matrix material, wherein said body is formed by the method as described herein.

In another aspect, it is proposed the use of a method as described herein for creating printed electronics.

In another aspect, it is proposed the use of a method as described herein for creating RF shielding.

In another aspect, it proposed the use of a method as described herein, for creating transistors.

In another aspect, it is proposed the use of a method as described herein for creating three dimensional geometries of conductive pathways.

Advantageously, the particle structure may comprise conductive pathways.

There is also provided a body comprising a particle structure fixated in a matrix material obtainable by the method described herein. The body may be used for creating printed electronics, RF shielding, transistors, strain sensors, force sensors, membrane switches, anisotropic conductive films, conductive tapes, three dimensional geometries of conductive pathways and combinations thereof. There are also provided printed electronics, RF shielding, transistors, strain sensors, force sensors, membrane switches, anisotropic conductive films, conductive tapes, three dimensional geometries of conductive pathways and combinations thereof including said body.

### BRIEF DESCRIPTION OF THE DRAWINGS

The invention will now be further described with reference to exemplary embodiments, with reference the enclosed drawings, wherein:

FIG. 1 is a schematic illustration of an embodiment of a Halbach arrangement.

FIG. 2 shows a flux diagram of a Halbach array.

FIG. 3a is a photograph showing particles in a viscous matrix after having been subjected to an electric field followed by curing.

FIG. 3b is a photograph showing particles in a viscous matrix.

FIG. 3c is a photograph showing particles in a viscous matrix after having been subjected to a magnetic field created by a Halbach array followed by curing.

FIG. 3d is a photograph showing particles in a viscous matrix after having been subjected to a magnetic field followed by an electric field and curing.

It should be noted that the drawings have not been drawn to scale and that the dimensions of certain features have been exaggerated for the sake of clarity.

### DETAILED DESCRIPTION OF PREFERRED EMBODIMENTS

As mentioned in the above, a magnetic field created by a Halbach arrangement may advantageously be used with the method described herein.

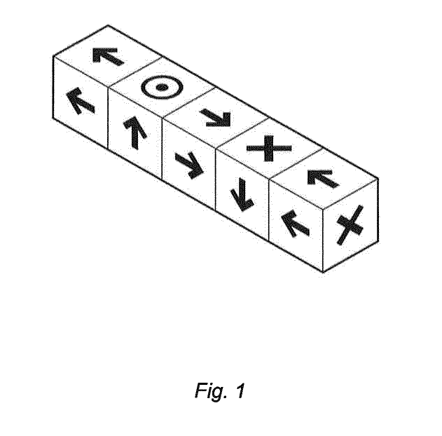

An embodiment of a Halbach array is illustrated in FIG. 1. Several pieces of magnets are put together. The arrows show the orientation of each piece's magnetic field. The Halbach array of FIG. 1 would give a strong field underneath the array, while the field above would cancel.

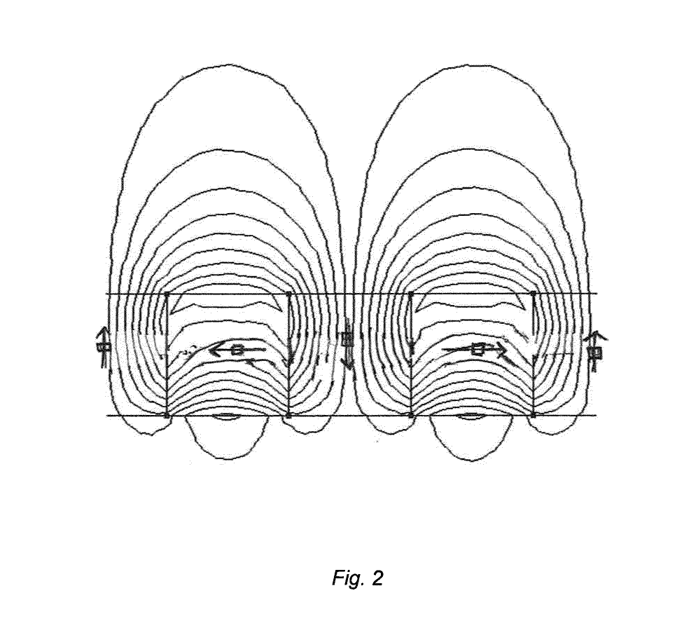

FIG. 2 shows the flux diagram of a Halbach array. The flux lines are augmented on the top side and virtually cancelled on bottom side. Thus, the overall effect is a one-sided flux

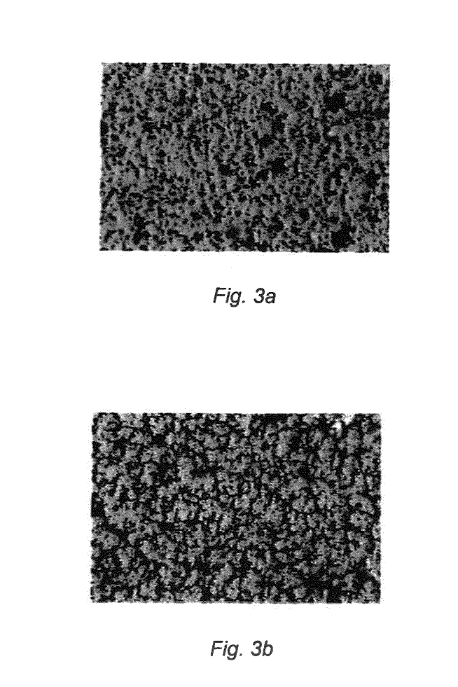

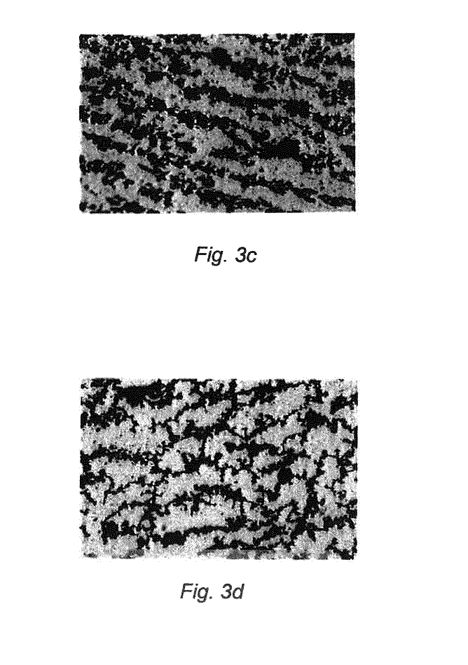

FIG. 3a illustrates silver-iron particles in an amount of 1.5 vol. % dispersed in a viscous matrix material after having been subjected to an electric field and curing. The matrix material was made of polyurethane. It can be seen that a network of particles is formed. The resulting body of particles in a matrix material was found to be electrically conductive.

FIG. 3b illustrates particles in an amount of 1.5 vol. % dispersed in a viscous matrix material after curing. The matrix material was a UV curable polyurethane from Dymax.

FIG. 3c illustrates silver-iron particles in an amount of 1.5 vol. % dispersed in a viscous matrix material after having been subjected to a magnetic field created by a Halbach array and curing. The matrix material was made of polyurethane. The photograph shows that assemblies of particles are formed. However, the resulting body of particles in a matrix was not electrically conductive.

FIG. 3d illustrates silver-iron particles in an amount of 1.5 vol. % dispersed in a viscous matrix material after having been subjected to a magnetic field created by a Halbach array in the form of a refrigerator magnet followed by an electric field and curing. The matrix material was made of polyurethane. The resulting material had a particle structure in the form of a network. The particles being conductive the resulting body was found to be electrically conductive. The electrical conductivity proved to be superior to the body in FIG. 3b in which only an electric field was used.

Hence, it is concluded that subjecting an amount of particles in a viscous matrix material to a magnetic field created by a Halbach array followed by application of an electric field and curing results in a body of particles in a matrix material with improved connectivity in the form of electrical conductivity compared to application of solely an electric field and curing.

When low amounts of particles were used the assemblies of particles or the particle structure had the form of conductive pathways aligned with the magnetic field lines. At higher amounts of particles the assemblies of particles or particle structure had the form of one or more networks. Depending on the particles used and the amount of particles the material resulting from the method described herein exhibited no, little or satisfactory electrical conductivity.

The bodies created using the method described herein may moreover present additional advantages and different properties as compared to those using prior art methods in which only a single field is used or a magnetic field is used repeatedly.

The invention is further illustrated by the following non-limitative examples.

### EXAMPLES

Silver coated iron particles were used in all samples below.

Electric field only vs magnetic and electric field

For preparation of a first sample, the silver coated iron particle was mixed with a viscous matrix material, the polymer Dymax 3094, such that the particles were uniformly dispersed in the matrix. The particle fraction was approximately 3 vol %. The dispersion was then coated on a PET substrate, so that the resulting film had a thickness of 100 μm.

For alignment, an interdigitated finger electrode was used, where every each finger has the opposite electric polarity compared to its neighbour on either side. The sample was placed on top of the electrode so that the PET substrate was between the electrode and the dispersed film. To align the particles, an alternating electric field was applied to the electrode, and the sample was moved back and forth over the electrode perpendicular the fingers for the duration of the both the alignment step and the curing step.

The field strength used was about 5 kV/cm, and the frequency was 20 kHz sine wave, applied for one minute to align the particles.

After alignment, the sample was cured using UV-light for 60 seconds. The film was then separated from the PET substrate, and the presence of conductive pathways confirmed by having the film bridge a 1 cm gap between two copper electrodes and measuring the resistance with a multimeter. In this case the measured resistance was about 10 kOhm. Hence, this first sample was prepared using an electrical field only, in accordance with prior art technology.

For preparation of a second sample, the same particles and particle concentration in the same viscous matrix was used. The particles were first subject to a magnetic field created by a Halbach array in the form of magnetic paper bought from Biltema, Norway. In this case the sample was passed back and forth over the Halbach array for 30 s. The movement of the sample was perpendicular to the striped domains of the Halbach magnet. This caused the particles to form a plurality of particle assemblies extending parallel with the direction of movement. The sample was then cured, separated from the substrate and measured in the same way as for the first sample. The measured resistance was in this case about 1 kOhm.

For preparation of a third sample, the sample was subjected first to the magnetic field of the Halbach array as described above (second sample), and then to the electric field of the electrode as described for the first sample. After curing and separating from the substrate, the measured resistance was 200 Ohm.

The examples above were different than those referred to in FIGS. 3a-3c.

As a control, a fourth sample was made where the sample was not subjected to neither electric nor magnetic field. In this case the resistance was outside the measuring range of the multimeter (>100 MOhm), illustrating that the 3 vol % concentration is below the percolation threshold for this particle.

Hence, in view of the above, it is understood that the magnetic field is indeed of importance when forming the particle structure of both the second and third sample. The resulting films show lower sheet resistance after having been aligned using a magnetic field created by a Halbach array. Furthermore, comparing FIG. 3b with FIGS. 3c and 3d, it is clear that using a Halbach array to align the particles sometimes also leads to more linear particle structures, as opposed to the more two-dimensional network in FIG. 3b.

Accordingly, the method as proposed herein may be used to provide bodies having different properties than those prepared in accordance with prior art methods.

It should be noted that the described features of the various embodiments may be combined with each other. Accordingly, no embodiment is intended to limit any combination of features which are presented in the embodiments, but rather to illustrate examples of embodiments.

1. A method for forming a particle structure fixated in a matrix material, the particle structure including at least an amount of particles within the matrix material, at least a portion of said amount of particles being at least one of paramagnetic and ferromagnetic, the method comprising:
subjecting the matrix material to a magnetic field created by a Halbach array so as to form particle assemblies;
subjecting the matrix material to an electric field so as to at least one of move and rotate the particle assemblies in the matrix material; and
securing said particle structure in the matrix material

2. The method according to claim 1, wherein the amount of particles are subjected to the magnetic field by moving the amount of particles through at least part of the magnetic field generated by the Halbach array.

3. The method according to any one of the previous claims, wherein the Halbach array is provided by at least one of a refrigerator magnet, a magnetic stripe, a magnetic paper, a magnetic tape and a Halbach magnetic cylinder.

4. The method according to any one of the previous claims, wherein said particle structure includes at least one pathway of particles extending through the matrix material.

5. The method according to claim 4, wherein the at least one pathway is a conductive pathway.

6. The method according to any one of the previous claims, wherein the amount of particles have a concentration in the matrix material being less than a percolation threshold.

7. The method according to any one of the previous claims, wherein the amount of particles have a concentration in the viscous matrix material in the a range from 0.1 to 10 vol %.

8. The method according to any one of the previous claims, wherein the amount of particles include particles comprising at least one of carbon, metal and metal alloys.

9. The method according to claim 8, wherein the amount of particles are selected from a group consisting of silver-iron particles, silver-nickel particles, graphite-nickel particles, nickel particles, carbon nanoparticles and mixtures thereof.

10. The method according to any one of the previous claims, wherein a size of the amount of particles is in a range from 0.5 micrometers to 150 micrometers.

11. The method according to any one of the previous claims, wherein the electric field is at least one of an AC field and a DC field.

12. The method according to any one of the previous claims, wherein the matrix material comprises a polymer.

13. The method according to any one of the previous claims, further comprising a body, the body comprising the particle structure fixated in the matrix material, wherein said body is obtainable by any one of the previous claims.

14. The method of claim 13, wherein the body is used for at least one of creating printed electronics, RF shielding, transistors, strain sensors, force sensors, membrane switches, anisotropic conductive films, conductive tapes, and three dimensional geometries of conductive pathways.
